(19) United States
(12) Patent Application Publication
(10) Pub. No.: US 2024/0364779 A1
(43) Pub. Date: Oct. 31, 2024

(54) DEVICE AND METHOD FOR UPLOADING FILE AND TERMINAL AND METHOD FOR DOWNLOADING FILE

(71) Applicant: ClouZen CO., LTD., Hwaseong-si (KR)

(72) Inventor: GOAN SOO SEONG, Seoul (KR)

(73) Assignee: ClouZen CO., LTD., Hwaseong-si (KR)

(21) Appl. No.: 18/139,905

(22) Filed: Apr. 26, 2023

(51) Int. Cl. H04L 67/1008; G06F 16/11; H04L 67/1097

(52) U.S. Cl. CPC H04L 67/1008; G06F 16/116; H04L 67/1097

(57) ABSTRACT

Provided are a device and method for uploading a file and a terminal and method for downloading a file. The method of uploading a file includes determining a format of an original file to be uploaded, when the original file is determined to be a large-size file, generating a reference file having a smaller size than the original file, transmitting the reference file to a first remote server using a first token, and transmitting the original file to a second remote server using a second token. The second remote server takes a longer time than the first remote server to respond to an access request.

### BACKGROUND

### 1. Field

The following description relates to additionally generating, storing, and managing summary files, as reference files, for facilitating understanding of multimedia files, such as videos and photos, in the case of storing large-size files, such as the videos and the photos, in a cloud storage server, such as a cloud storage server, and thus increasing efficiency in network use by enabling a user to view large-size files such as videos and photos without downloading the large-size files and edit reference files.

### 2. Description of Related Art

As the resolutions of videos, photos, etc. increase with the development of electronic devices, multimedia files are gradually increasing in size. On the other hand, due to the development of the Internet and networks, the number of cases of storing multimedia files in a remote storage device rather than a personal local storage is gradually increasing. Such cloud storage devices currently include Dropbox of Dropbox Inc., OneDrive of Microsoft Inc, AWS of Amazon Inc., etc.

Here, cloud storage devices vary in cost-per-capacity depending on the types of used media, that is, various media, such as a solid-state drive (SSD), a hard-disk drive (HDD), a linear tape-open (LTO), etc., and the amount of a network used also costs as much as the amount of data used. For example, in the case of Amazon AWS, a frequent access storage costs five or more times as much as an archive storage for the same capacity.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a method of reducing the cost of using a cloud storage device and increasing the efficiency of network use by generating, in the case of storing video or photo files in the cloud storage device, summary files of the video or photo files as reference files, storing the reference files in a storage medium which takes a shorter time to respond to an access request but is expensive to use, and storing the original files having large sizes in a storage medium for keeping which takes a longer time to respond to an access request but is inexpensive to use.

The following description also relates to a method of reducing the number of unnecessary downloads of original files and minimizing network usage by displaying reference files instead of original files for the purpose of a rapid search in the case of searching for photo or video files and allowing download of an original file only when it is necessary to download the corresponding photo or video file.

Technical objects to be achieved in the present disclosure are not limited to those described above, and other technical objects that have not been described will be clearly understood by those of ordinary skill in the art from the following description.

In one general aspect, a method of uploading a file includes determining a format of an original file to be uploaded, when the original file is determined to be a large-size file, generating a reference file having a smaller size than the original file, transmitting the reference file to a first remote server using a first token, and transmitting the original file to a second remote server using a second token. The second remote server takes a longer time than the first remote server to respond to an access request.

The original file may be a video file, and the reference file may be a proxy video file.

The original file may be a photo file, and the reference file may be a thumbnail image file.

In another general aspect, a method of downloading a file includes displaying a list of reference files on a screen, selecting a first reference file from among the reference files according to an input of a user, downloading the first reference file from a first server using a first token, and downloading an original file corresponding to the first reference file from a second server using a second token. The second remote server takes a longer time than the first remote server to respond to an access request.

In another general aspect, a device for uploading a file includes a memory configured to store program instructions and a processor connected to the memory and configured to operate according to the program instructions. The program instructions cause the processor to perform operations of determining a format of an original file to be uploaded, when the original file is determined to be a large-size file, generating a reference file having a smaller size than the original file, transmitting the reference file to a first remote server using a first token, and transmitting the original file to a second remote server using a second token. The second remote server takes a longer time than the first remote server to respond to an access request.

In another general aspect, a terminal includes a memory configured to store program instructions and a processor connected to the memory and configured to operate according to the program instructions. The program instructions cause the processor to perform operations of displaying a list of reference files on a screen, selecting a first reference file from among the reference files according to an input of a user, downloading the first reference file from a first server using a first token, and downloading an original file corresponding to the first reference file from a second server using a second token. The second server takes a longer time than the first server to respond to an access request.

Other features and aspects will be apparent from the following detailed description, the drawings, and the claims.

### BRIEF DESCRIPTION OF THE DRAWINGS

FIG. 1 is a diagram showing an example of a wireless network (100) according to exemplary embodiments of the present disclosure.

FIG. 2 is a diagram showing a configuration of an example of an upload device (200) according to exemplary embodiments of the present disclosure.

FIG. 3 is a diagram illustrating each element of a memory related to implementation of an upload function among hardware elements of the upload device (200).

FIG. 4A is a flowchart illustrating a method of uploading a multimedia file from the upload device (200) to a cloud storage server (300).

FIG. 4B is a flowchart illustrating a method of uploading a multimedia file from the upload device (200) to the cloud storage server (300) according to the size of an original file.

FIG. 5 is a diagram showing a hardware configuration of a cloud storage server (500) for implementing the present disclosure.

FIG. 6A is a set of tables showing an example of lists (600) of files stored in a high-speed storage server Sf (551) and a low-speed storage server Sa (552) in a cloud server using the upload device (200) according to an exemplary embodiment of the present disclosure.

FIG. 6B is a set of tables showing another example of lists (600-1) of files stored in the high-speed storage server Sf (551) and the low-speed storage server Sa (552) in the cloud server using the upload device (200) according to another exemplary embodiment of the present disclosure.

FIG. 7 is a diagram showing a hardware configuration of a smartphone (700) which is an example of a mobile device for performing download and multimedia file search functions of the present disclosure.

FIG. 8 is a sequence diagram illustrating a method of searching for a multimedia file stored in a cloud server through a smartphone or downloading the multimedia file to the smartphone according to an exemplary embodiment of the present disclosure.

FIG. 9 is a screen of the smartphone on which a list (900) of files which are stored in the high-speed storage server Sf and received from the cloud server is displayed.

FIG. 10 is a diagram showing a process after a smartphone receives a list of files stored in the high-speed storage server Sf from the cloud server and displays the list (900) of files on the screen of the smartphone.

FIG. 11 is a sequence diagram illustrating a method of searching for a multimedia file stored in a cloud server through a smartphone or downloading the multimedia file to the smartphone according to another exemplary embodiment of the present disclosure.

FIG. 12 is a screen of a smartphone on which a list (1200) of files which is downloaded from the high-speed storage server Sf is displayed.

FIG. 13 is a screen illustrating a method of searching for a multimedia file stored in a cloud server through a smartphone or downloading the multimedia file to the smartphone according to another exemplary embodiment of the present disclosure.

Throughout the accompanying drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The above-described and additional aspects are embodied through embodiments described with reference to the accompanying drawings. It will be understood that elements of each of the embodiments may be combined in various ways within one embodiment unless otherwise stated or contradicted by one another. Each block in a block diagram may be a representation of a physical part in some cases, but may be a logical representation of a portion of a function of one physical part or a function of a plurality of physical parts in other cases. In some cases, a block or entry of a portion of the block may be a set of program instructions. All or some of the blocks may be implemented as hardware, software, or a combination thereof.

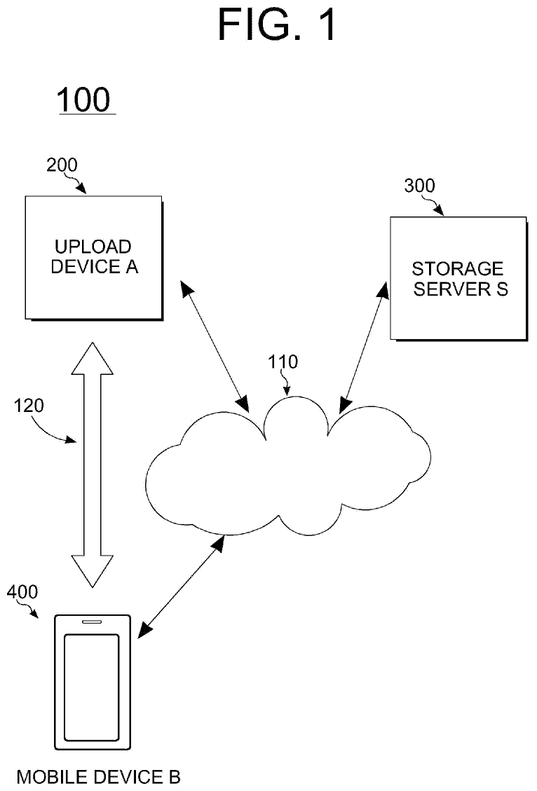

### <Overall Description of FIG. 1 of the Present Disclosure>

FIG. 1 is a diagram showing an example of a wireless network 100 according to exemplary embodiments of the present disclosure. The exemplary embodiment of the wireless network shown in FIG. 1 is only for illustration, and other embodiments of a wireless network 100 may be used without departing from the scope of the present disclosure. As shown in FIG. 1, the wireless network 100 includes a cloud storage server 300 for storing large-size multimedia files, such as videos, photos, etc., and small-size files, such as text files and the like, an upload device 200 for uploading large-size multimedia files, such as videos, photos, etc., and small-size files, such as text files and the like, to the storage server 300, and a mobile device 400 for downloading or searching for multimedia files, such as videos, photos, etc., and small-size files, such as text files and the like, stored in the storage server 300. The cloud storage server 300 communicates with the upload device 200 and the mobile device 400 through the Internet 110 in a wired or wireless manner. In the present disclosure, a device that is carried by a user to upload large-size multimedia files, such as videos, photos, etc., and small-size files, such as text files and the like, to the storage server 300 is illustrated as the upload device 200. However, the upload device 200 is not limited thereto, and any device, such as a smartphone, a personal computer (PC), etc., that may access the cloud storage server 300 through the Internet may be the upload device 200. The cloud storage server 300 communicates with the upload device 200 and the mobile device 400 in a wired or wireless manner using a wireless communication technology such as fifth generation (5G), Long Term Evolution (LTE), LTE-advanced (LTE-A), worldwide interoperability for microwave access (WiMAX), Wi-Fi, etc. In the present disclosure, the storage server 300 is assumed to be a commercially provided cloud server. However, concepts of the present disclosure are not limited thereto and may also be applied to a personal cloud server. The storage server 300 may be any storage device that accesses an upload device in a wired or wireless manner to receive large-size files, such as videos, photos, etc., from the upload device and store the received large-size files.

The upload device 200 may communicate with the storage server 300 and the mobile device 400 through the Internet 110 using its own communication function. The upload device 200 may also access the Internet 110 through a wired Universal Serial Bus (USB) connection, direct connect, etc. with the mobile device 400 using wireless access of the mobile device 400.

### <Hardware Configuration of Upload Device>

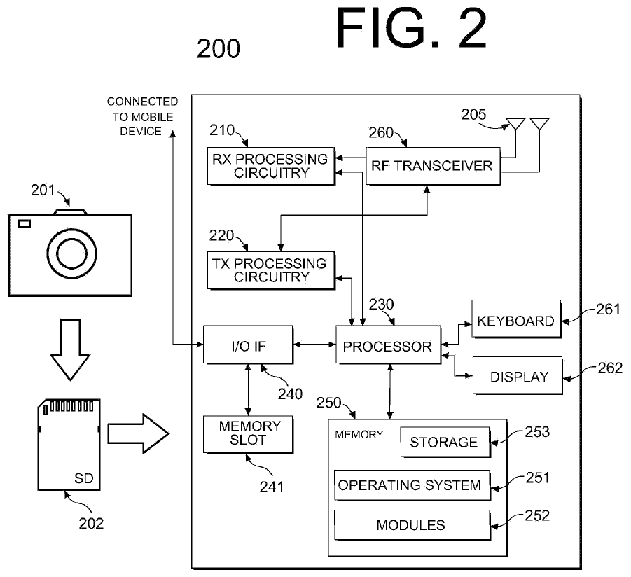

FIG. 2 is a diagram showing a configuration of an example of an upload device 200 according to exemplary embodiments of the present disclosure. The exemplary embodiment of the upload device 200 shown in FIG. 2 is only for illustration. The upload device 200 includes a variety of elements and is not limited to descriptions herein.

The upload device 200 according to the present disclosure is a device dedicated to file upload which performs a function of storing files which are stored in an external storage device, such as a USB memory, a memory stick, etc., in the cloud storage server, a portable device, such as a smartphone, a PC, etc. through the Internet using wired or wireless access. The upload device 200 includes elements shown in FIG. 2 overall.

In the case of uploading a multimedia file to the storage server 300, such as a cloud storage, through the Internet 110 using the upload device 200, the user first captures an image using an imaging device 201 such as a digital camera. Subsequently, the user separates an external storage device 202, such as a memory stick, a USB memory, etc., for storing multimedia files of captured videos, photos, etc. from the imaging device 201 and inserts the external storage device 202 into an external memory slot 241 of the upload device 200.

As shown in FIG. 2, the upload device 200 includes an antenna 205, a radio frequency (RF) transceiver 260, transmission (TX) processing circuitry 220, and reception (RX) processing circuitry 210. Also, the upload device 200 includes a processor 230, an input/output (I/O) interface (IF) 240, a keyboard 261, a display 262, and a memory 250. The memory 250 includes an operating system (OS) 251 and one or more operation modules 252.

The RF transceiver 260 may transmit an upload RF signal transmitted to the storage server 300 from the antenna 205 through the wired or wireless network 110 including the Internet. Also, the upload device 200 may access the mobile device 400 using a wired connection through the I/O IF 240, such as a USB port, or using a direct wireless connection, such as WiFi direct, to be connected to the Internet 110 using a wireless connection of the mobile device 400. The RF transceiver 260 filters, decodes, and/or digitizes a wireless signal required for data transmission and transmits the wireless signal to the antenna 205. Also, the RF transceiver 260 receives a signal from the antenna 205 and transmits the signal to the RX processing circuitry 210. The RX processing circuitry 210 transmits the processed signal to the processor 230 for data processing and conversion.

The TX processing circuitry 220 receives an uplink data signal (e.g., video data, photo data, text data, etc.) from the processor 230. The TX processing circuitry 220 encodes, multiplexes, and/or digitizes the data signal and transmits the data signal to the RF transceiver 260, and the RF transceiver 260 converts a data signal received from the TX processing circuitry 220 into an RF signal to be transmitted through the antenna 205.

The processor 230 may include one or more processors and control overall operations of the upload device 200 by executing the basic OS 251 stored in the memory 250. For example, the processor 230 may control reception of forward channel signals and transmission of reverse channel signals through the RF transceiver 260, the RX processing circuitry 210, and the TX processing circuitry 220 according to well-known principles. In some embodiments, the processor 230 may include a general-use processor or a plurality of microprocessors.

The processor 230 may execute other processes and the modules 252 residing on the memory 250. According to a request from a process in execution, the processor 230 stores data in the memory 250 and also reads data from the memory 250. In some embodiments, the processor 230 is configured to execute the modules 252 on the basis of the OS 251 or according to instructions input from the storage server 300 or the user. Also, the processor 230 is coupled to the I/O IF 240 which provides a capability of accessing other devices, such as a laptop computer, a portable computer, a smartphone, etc., to the upload device 200. The I/O IF 240 is a communication path between the peripherals and the processor 230.

Further, the processor 230 may be coupled to the keyboard 261 and the display 262. The user of the upload device 200 may input a command and/or data required for manipulation of the upload device 200 to the upload device 200. The display 262 may be, for example, a liquid crystal display (LCD), a light-emitting diode (LED) display, or another display that may show upload and download states and the like of the upload device 200 in text and/or render at least limited graphics.

The memory 250 is coupled to the processor 230. A part of the memory 250 may include a storage 253 such as a random access memory (RAM) and/or a flash memory or a read-only memory (ROM), etc.

### <Hardware Configuration Related to Upload Function of Upload Device>

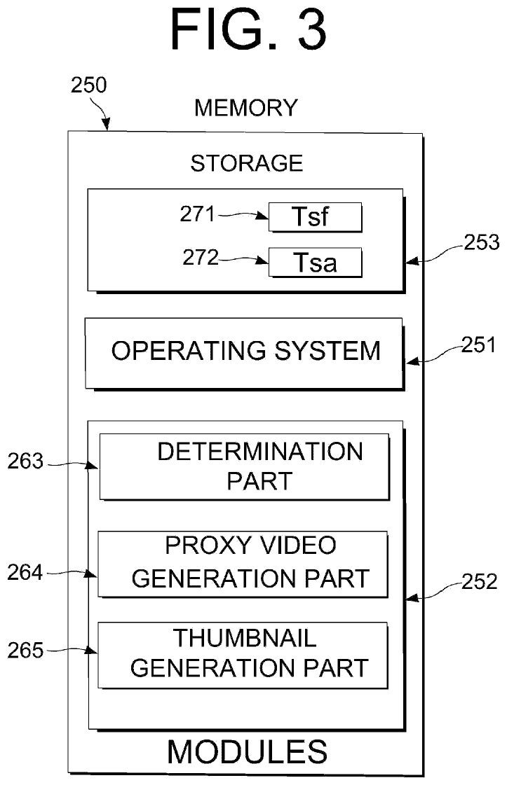

FIG. 3 is a diagram illustrating each element of a memory and modules related to implementation of an upload function among hardware elements of the upload device 200.

According to a general method well known in the corresponding technical field, the upload device 200 is issued a token Tsf (271) for accessing the high-speed storage server Sf included in the storage server 300 and a token Tsa (272) for accessing the low-speed storage server Sa and stores the tokens Tsf (271) and Tsa (272) in the storage 253. As a part of the processing modules 252, the upload device 200 includes a determination part 263 that determines whether a file to be uploaded is a video, a photo, or a general file.

Also, as a part of the processing modules 252, the upload device 200 includes a proxy video generation part 264 that generates a low-quality and small-size summary video, that is a proxy video, as a reference file on the basis of a high-quality and large-size video file.

Further, as a part of the processing modules 252, the upload device 200 includes a thumbnail generation part 265 that generates a thumbnail image file which is a small-size and low-quality image file from a large-size and high-quality photo file.

Each of the determination part 263, the proxy video generation part 264, and the thumbnail generation part 265 is present in the form of a program instruction set in the memory 250, executed by the processor 230 to be implemented as one of the executable program modules 252, and performs a necessary operation.

### <Method of Uploading Multimedia File>

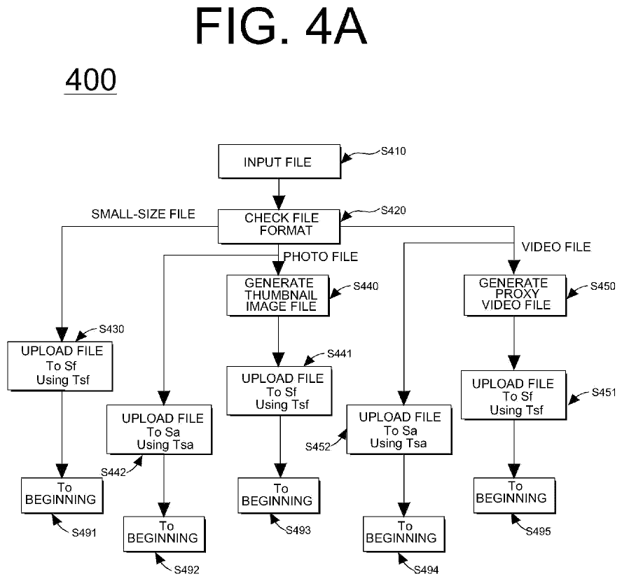

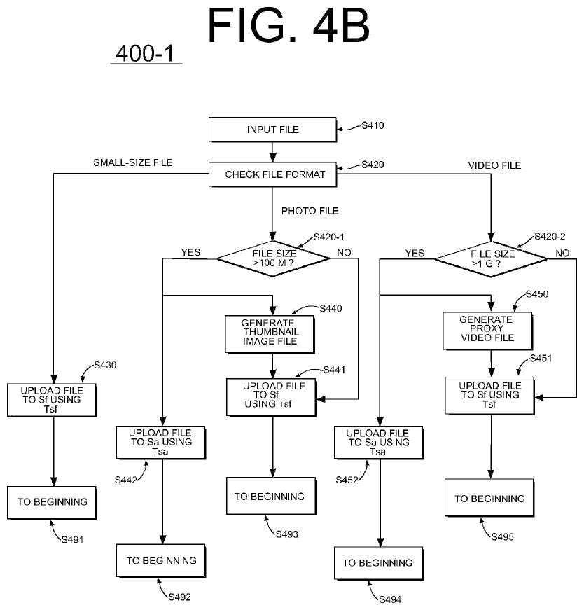

FIG. 4A is a flowchart illustrating a method of uploading a multimedia file from the upload device 200 to the cloud storage server 300.

According to a general method well known in the corresponding technical field, first, the user inputs an external storage memory, such as a memory card storing a specific file, into the upload device 200 (S410). The upload device to which an instruction to upload the specific file is input by the user determines which one is the file among a video file, a photo file, and a small-size file, such as a text file, through the determination part 263 (S420).

When the original file is determined by the determination part 263 to be a small-size file, such as a text file, the upload device 200 uploads the small-size file to the expensive high-speed cloud server Sf using a token Tsf which is issued in advance by the high-speed storage server Sf (S430). After that, the process of FIG. 4A is repeated for a next file included in the memory card (S491).

Meanwhile, when the original file is determined to be a large-size photo file by the determination part 263, the upload device 200 generates a thumbnail image file for the photo file through the thumbnail generation part 265 (S440). When the generation of the thumbnail image file for the photo file is completed, the upload device 200 uploads the generated thumbnail image file to the high-speed storage server Sf using the token Tsf which is issued in advance by the high-speed storage server Sf (S441). When the upload is completed, the process is finished (S492). Also, at the same time as the thumbnail image file is generated or before or after the generation, the upload device 200 uploads the original photo file to the inexpensive low-speed cloud server Sa using a token Tsa which is issued in advance by the low-speed storage server Sa (S442). When the upload is completed, the process is finished (S493) and returns to the beginning for a next file in the memory card.

Meanwhile, when the original file is determined to be a video file by the determination part 263, the upload device 200 generates a proxy video file for the video file through the proxy video generation part 264 (S450). When the generation of the proxy video file for the video file is completed, the upload device 200 uploads the generated proxy video file to the expensive high-speed cloud server Sf using the token Tsf which is issued in advance by the high-speed storage server Sf (S451). When the upload is completed, the process is finished (S495). Also, at the same time as the proxy video file is generated or before or after the generation, the upload device 200 uploads the original video file to the inexpensive low-speed cloud server Sa using the token Tsa which is issued in advance by the low-speed storage server Sa (S452). When the upload is completed, the process is finished (S494) and returns to the beginning for a next file in the memory card.

When the generation of a thumbnail image file is completed, the thumbnail generation part 265 gives the thumbnail image file a filename related to the original filename so that the original file related to the thumbnail image file can be simply identified using the filename. For example, when the names of original photo files are “Photo_01” and “Photo_02,” thumbnail image files generated from the original photo files are automatically named “Thumb_Photo_01” and “Thumb_Photo_02” so that the original photo files related to the thumbnail image files can be simply identified using the names of the thumbnail image files. Alternatively, an operation may be provided for the user to additionally input the name of a thumbnail image file.

When the generation of a proxy video file is completed, the proxy video generation part 264 gives the proxy video file a filename related to the original filename so that the original file related to the proxy video file can be simply identified using the filename. For example, when the names of original video files are “Video_01” and “Video_02,” proxy video files generated from the original video files are automatically named “Proxy_Video_01” and “Proxy_Video_02” so that the original video files related to the proxy video files can be simply identified using the names of the proxy video files. Alternatively, an operation may be provided for the user to additionally input the name of a proxy video file.

In addition, the upload device may store information indicating that a file to be uploaded is a thumbnail image file or a proxy video file in the high-speed storage server Sf in the form of metadata of a corresponding reference file. The metadata may include link information of an original video file or photo file corresponding to the reference file, and thus another device or a third party receiving the reference file can download the original video file or photo file by referring to the metadata.

For example, it is assumed that five files Text_01, Video_01, Video_02, Photo_01, and Photo_02 are stored in the external storage device, Text_01 is a text file, Video_01 and Video_02 are video files, and Photo_01 and Photo_02 are photo files. According to the algorithm of FIG. 4A, the upload device 200 transmits Text_01 which is a text file to the high-speed storage server Sf of the cloud server using the token Tsf. Also, according to the algorithm of FIG. 4A, the upload device 200 generates proxy video files Proxy_Video_01 and Proxy_Video_02 respectively for the original video files Video_01 and Video_02, generates thumbnail image files Thumb_Photo_01 and Thumb_Photo_02 respectively for the original photo files Photo_01 and Photo_02, and transmits the proxy video files Proxy_Video_01 and Proxy_Video_02 and the thumbnail image files Thumb_Photo_01 and Thumb_Photo_02 to the high-speed storage server Sf of the cloud server 300 using the token Tsf. Meanwhile, according to the algorithm of FIG. 4A, the upload device 200 transmits the original video files Video_01 and Video_02 and the original photo files Photo_01 and Photo_02 to the low-speed storage server Sa of the cloud server using the token Tsa.

In the present embodiment, it is described that the determination part 263 determines the attribute of a file, such as whether the file is a small-sized file, a video file, or a photo file, and it is automatically determined whether the file to be uploaded to the cloud server will be stored in the high-speed storage server Sf or the low-speed storage server Sa according to the attribute of the file. However, a thumbnail image file or a proxy video file may be generated on the basis of an additional attribute of the file. For example, when an original file is a video file, a file having a specific size or more may be simultaneously stored in the low-speed storage server Sa and the high-speed storage server Sf, and a file having less than the specific size may be stored only in the high-speed storage server Sf. Also, it may be determined for each file whether to generate a thumbnail image file or a proxy video file in the high-speed storage server Sf on the basis of an input from the user.

FIG. 4B is an embodiment similar to FIG. 4A. According to this embodiment, however, when a video file which is an original file has less than a specific size (e.g., 1 gigabyte or more), the original file is not stored in the low-speed storage server Sa but in the high-speed storage server Sf, and when a photo file which is an original file is less than a specific size (e.g., 100 megabytes or more), the original file is not stored in the low-speed storage server Sa but in the high-speed storage server Sf. In the drawings, it is assumed that an element having the same reference numeral performs the same function unless otherwise described. As shown in FIG. 4B, when an original file is determined to be a large-size photo file by the determination part 263, the upload device 200 determines whether the original file is greater than a certain size, for example, 100 megabytes, in operation S420-1. When it is determined that the original file is greater than the certain size (Yes), the processor 230 uploads the original photo file to the low-speed storage server Sa using a token Tsa (S442) like in the operation of FIG. 4A, generates a thumbnail image file (S440), and then uploads the generated thumbnail image file by transmitting the thumbnail image file to the high-speed storage server Sf using a token Tsf (S441). When it is determined that the original file is the certain size or less (No), the processor 230 uploads the original photo file by transmitting the original photo file to the high-speed storage server Sf using the token Tsf without generating a thumbnail image of the original file (S441).

Also, when the original file is determined to be a large-size video file by the determination part 263, the upload device 200 determines whether the original file is greater than a certain size, for example, 1 gigabyte, in operation S420-2. When it is determined that the original file is greater than the certain size (Yes), the processor 230 uploads the original video file to the low-speed storage server Sa using the token Tsa (S452) like in the operation of FIG. 4A, generates a proxy video file (S450), and then uploads the generated proxy video file by transmitting the proxy video file to the high-speed storage server Sf using the token Tsf (S451). When it is determined that the original file is the certain size or less (No), the processor 230 uploads the original video file by transmitting the original video file to the high-speed storage server Sf using the token Tsf without generating a proxy video of the original file (S451).

### <Hardware Configuration of Cloud Server>

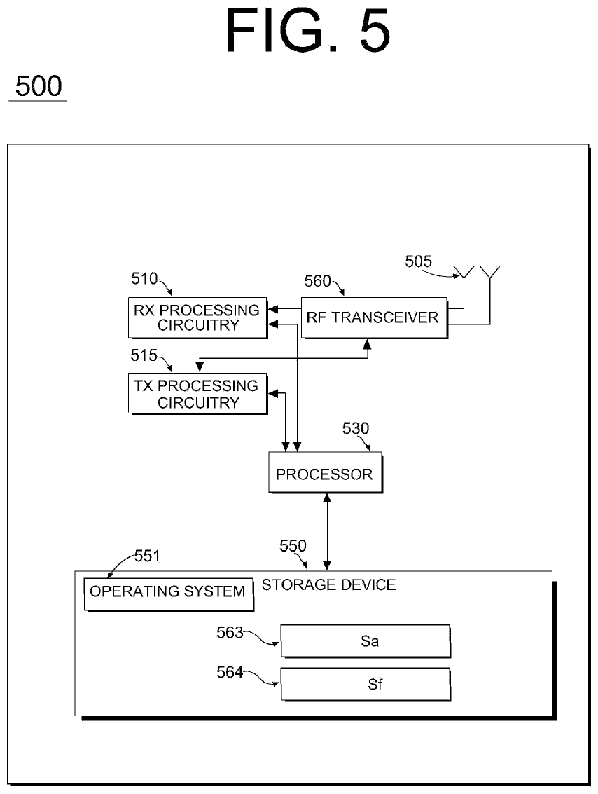

FIG. 5 is a diagram showing a hardware configuration of a cloud storage server 500 for implementing the present disclosure. The exemplary embodiment of the cloud storage server 500 shown in FIG. 5 is only for illustration. The cloud storage server 300 includes a variety of elements and is not limited to descriptions herein.

According to an exemplary embodiment of the present disclosure, the storage server may include the high-speed storage server Sf which rapidly responds to an external access but is expensive and the low-speed archive storage server Sa which slowly responds to an external access but is inexpensive. Also, tokens Tsf and Tsa are respectively required for an external device to access the high-speed storage server Sf and the low-speed storage server Sa through the Internet.

As shown in FIG. 5, the cloud storage server 500 includes an antenna 505, an RF transceiver 560, TX processing circuitry 515, and RX processing circuitry 510. Also, the cloud storage server includes a processor 530 and a storage device 550. The storage device 550 includes an OS 551 and one or more storage units 563 and 564. The one or more storage units 563 and 564 may include the low-speed storage server Sa and the high-speed storage server Sf.

The RF transceiver 560 receives an upload RF signal transmitted from the upload device 200 and the mobile device 400, from the antenna 505 through the wired or wireless network 110 including the Internet. The RF transceiver 560 transmits the upload RF signal to the RX processing circuitry 510, and the RX processing circuitry 510 generates a data signal by filtering, decoding, and/or digitizing the received RF signal. The data signal from the RX processing circuitry 510 is transmitted to the processor 530 for additional processing.

The TX processing circuitry 515 receives downlink data (e.g., video or photo data) from the processor 530. The TX processing circuitry 515 generates an RF TX signal by encoding, multiplexing, and/or digitizing the download data. The generated RF TX signal is transmitted to other devices through the antenna 505.

The processor 530 may include one or more processors or other processing devices and control overall operations of the cloud storage server 500 by executing the basic OS 551 stored in the storage device 550. For example, the processor 530 may control reception of forward channel signals and transmission of reverse channel signals through the RF transceiver 560, the RX processing circuitry 510, and the TX processing circuitry 515 according to well-known principles. In some embodiments, the processor 530 may include at least one microprocessor or microcontroller.

The processor 530 may execute other processes and modules residing on the storage device 550. According to a request from a process in execution, the processor 530 may move data to or from the storage device 550. In some embodiments, the processor 530 is configured to execute modules on the basis of the OS 551 or according to signals received from the storage device 550 or the user.

The storage device 550 is coupled to the processor 530. As shown in FIG. 5, the cloud storage server of the present disclosure may include the high-speed storage server Sf which rapidly responds to an external access but is generally expensive and the low-speed archive storage server Sa which does not rapidly respond to an external access and is generally inexpensive. For example, the cloud storage server 500 may include a solid-state drive (SSD) as the high-speed storage server Sf and a hard disk drive (HDD) as the low-speed storage server Sa, but the high-speed storage server Sf and the low-speed storage server Sa are not limited to a combination of an SSD and an HDD.

FIG. 5 illustrates that the high-speed storage server Sf and the low-speed storage server Sa are present in the same server device 500, but the high-speed storage server Sf and the low-speed storage server Sa may be physically separated from each other. Also, the high-speed storage server Sf and the low-speed storage server Sa may be separate cloud storage servers that are run by different service providers. Further, using a personal storage and a commercial storage in combination, such as using a personal remote storage server as the high-speed storage server Sf and a commercial storage server as the low-speed storage server Sa, does not depart from the spirit of the present disclosure.

### <Example of File Upload>

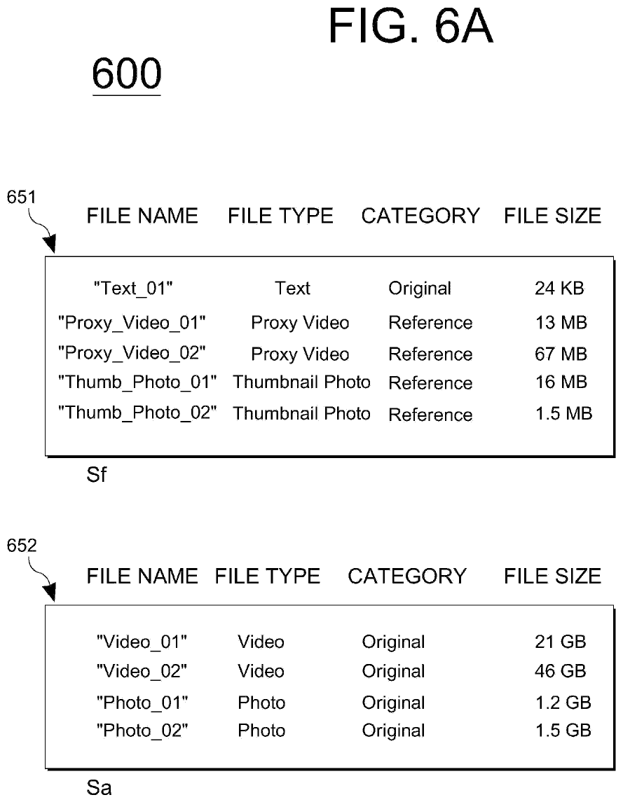

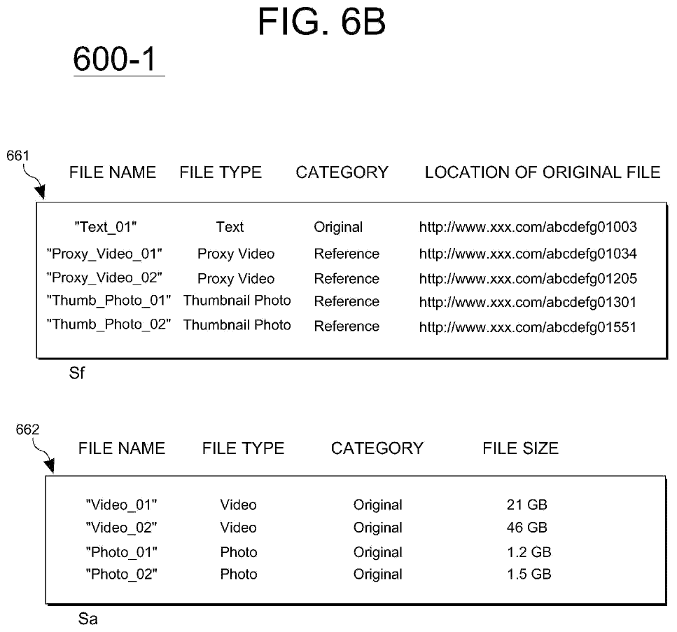

FIG. 6A is a set of tables showing an example of lists 600 of files stored in a high-speed storage server Sf (651) and a low-speed storage server Sa (652) in the cloud server using the upload device 200 according to an exemplary embodiment of the present disclosure.

The high-speed storage server Sf (651) stores the original file of the text file “Text_01.” Also, instead of original files of videos and photos, the high-speed storage server Sf (651) stores the proxy video files “Proxy_Video_01” “and “Proxy_Video_02” and the thumbnail image files “Thumb_Photo_01” and “Thumb_Photo_02” as reference files of the original files. On the other hand, the low-speed storage server Sa (652) stores the original files “Video_01,” “Video_02,” “Photo_01,” and “Photo_02” of the videos and the photos. The user may access the high-speed storage server Sf and refer to the file lists and thereby see that the original video files “Video_01” and “Video_02” and the original photo files “Photo_01” and “Photo_02” are stored in the low-speed storage server Sa. Accordingly, the user can rapidly check the list of files stored in the low-speed storage server Sa by referring to the file list stored in the high-speed storage server Sf through the upload device 200 or the mobile device 400 without waiting for a response from the low-speed storage server Sa having a low response speed. Also, when the reference files are downloaded from the high-speed storage server Sf, it is possible to roughly check the content of the original files without downloading the original video files “Video_01” and “Video_02” and the original photo files “Photo_01” and “Photo_02” from the low-speed storage server Sa.

FIG. 6B is a set of tables showing another example of lists 600-1 of files stored in the high-speed storage server Sf (661) and the low-speed storage server Sa (662) in the cloud server using the upload device 200 according to another exemplary embodiment of the present disclosure.

FIG. 6B is different from FIG. 6A in that a list 651 of files stored in the high-speed storage server Sf (661) includes location information of original files corresponding to reference files in the low-speed storage server Sa (662) instead of or in addition to file size information. Since file lists 600-1 stored in the high-speed storage server Sf (661) include information on the original files corresponding to the reference files, it is possible to easily transmit the locations of the original files by transmitting the file lists 600-1 to another device or a third party.

### <Hardware Configuration of Mobile Device>

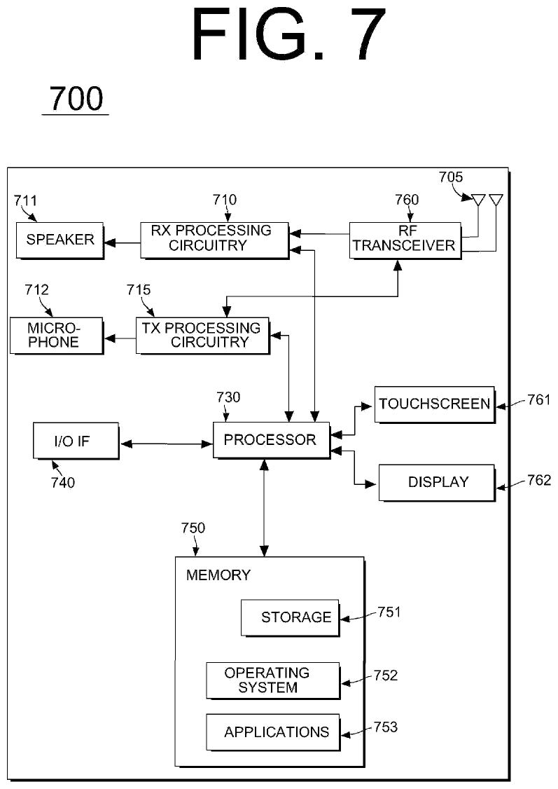

FIG. 7 is a diagram showing a hardware configuration of a smartphone 700 which is an example of a mobile device for performing download and multimedia file search functions of the present disclosure. The smartphone includes an antenna 705, an RF transceiver 760, TX processing circuitry 715, a microphone 712, and RX processing circuitry 710. Also, the smartphone includes a speaker 711, a processor 730, an I/O IF 740, a touchscreen 761, a display 762, and a memory 750. The memory 750 includes an OS 752 and one or more applications 753. The RF transceiver 760 receives an internal RF signal transmitted from a server in the network 110 through the antenna 705. The RF transceiver 760 generates an intermediate frequency (IF) or baseband signal by down-converting the internal RF signal. The IF or baseband signal is transmitted to the RF processing circuitry 710 which generates a processed baseband signal by filtering, decoding, and/or digitizing the baseband or IF signal. The RX processing circuitry 710 transmits the processed baseband signal to the speaker 711 (e.g., as voice data) or to the processor 730 for additional processing (e.g., as web browsing data).

The TX processing circuitry 715 receives analog or digital voice data from the microphone 712 or receives other external baseband data (e.g., web data, email, or bidirectional videogame data) from the processor 730. The TX processing circuitry 715 generates a processed baseband or IF signal by encoding, multiplexing, and/or digitizing the external baseband data. The RF transceiver 760 receives the processed external baseband or IF signal from the TX processing circuitry 715 and up-converts the baseband or IF signal into an RF signal which will be transmitted through the antenna 705.

The processor 730 may include one or more processors or other processing devices and control overall operations of the smartphone 700 by executing the basic OS 752 stored in the memory 750. For example, the processor 730 may control reception of forward channel signals and transmission of reverse channel signals through the RF transceiver 760, the RX processing circuitry 710, and the TX processing circuitry 715 according to well-known principles. In some embodiments, the processor 730 may include at least one microprocessor or microcontroller.

According to a request from a process in execution, the processor 730 may move data to or from the memory 750. In some embodiments, the processor 730 is configured to execute applications 753 on the basis of the OS 752 or according to signals received from servers or an operator. Also, the processor 730 is coupled to the I/O IF 740 which provides a capability of being connected to other devices, such as a laptop computer, a portable computer, etc., to the smartphone 700. The I/O IF 740 is a communication path between the peripherals and the processor 730.

Also, the processor 730 is coupled to the touchscreen 761 and the display 762. The operator of the smartphone 700 may input data to the smartphone 700 using the touchscreen 761. The display 762 may be, for example, an LCD, an LED display, or another display that may show text from websites and/or render at least limited graphics.

The memory 750 is coupled to the processor 730. A part of the memory 750 may include a RAM, and another part of the memory 750 may include a flash memory or a ROM.

### <Operation Method of Software on Mobile Device>

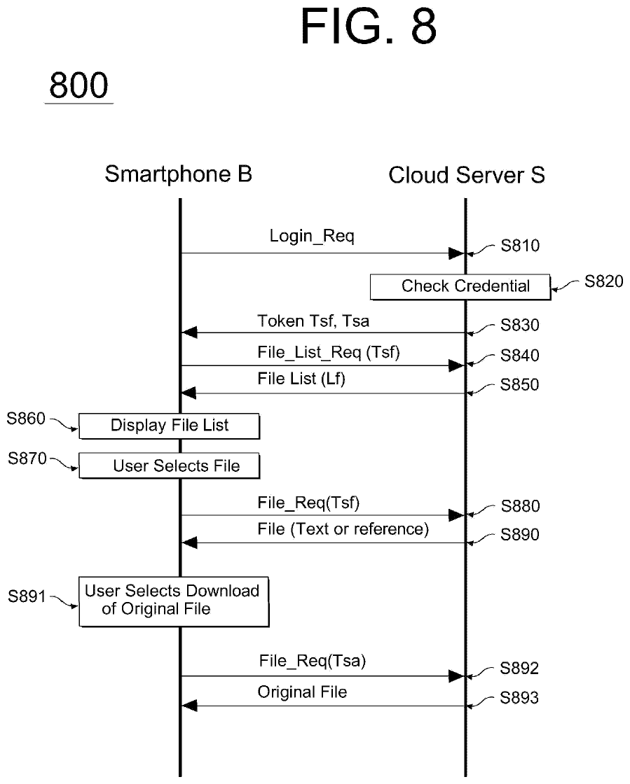

FIG. 8 is a sequence diagram illustrating a method of searching for a multimedia file stored in a cloud server through a smartphone or downloading the multimedia file to the smartphone according to an exemplary embodiment of the present disclosure.

A user who wants to search for or edit multimedia files stored in a cloud server through a mobile device, such as a smartphone, or download the multimedia files to the smartphone, first executes an access application Ba on the smartphone by clicking the icon of the access application BA so that the smartphone accesses the cloud server through the Internet.

Specifically, when the user starts executing the access application Ba by clicking the icon of the access application Ba on the smartphone, the smartphone transmits a login request Login_Req to the high-speed storage server Sf of the cloud server (S810).

When the login request Login_Req is received from the smartphone, the cloud server checks the credential of the login request Login_Req (S820). When it is determined that the login request Login_Req is valid as a result of checking the credential of the login request Login_Red, the cloud server issues tokens Tsf and Tsa for access to the high-speed storage server Sf and the low-speed storage server Sa and transmits the tokens Tsf and Tsa to the smartphone (S830). The mobile device 400, such as the smartphone, receiving the tokens Tsf and Tsa from the cloud server stores the tokens Tsf and Tsa in a storage 751 thereof and requests transmission of a file list stored in the high-speed storage server Sf with the token Tsf (S840). The cloud server checks the token Tsf included in the file list request and transmits a list Lf of files stored in the high-speed storage server Sf to the smartphone (S850).

The smartphone receives the list Lf of files stored in the high-speed storage server Sf from the cloud server and then displays a list of files stored in the high-speed storage server Sf on the screen of the smartphone on the basis of the file list Lf (S860).

The smartphone displays the file list including filenames of the files stored in the high-speed storage server Sf, the type of each file, file sizes, operations for the files, and download availability representing that the original file of a corresponding file is stored in the low-speed storage server Sa, to the user through the screen.

When the user touches and selects an original text file, a thumbnail image file, or a proxy video file displayed in the file list (S870), the smartphone requests that the cloud server transmit the selected file with the token Tsf (S880). The cloud server checks the token Tsf included in the file request and transmits the requested thumbnail image file or proxy video file to the smartphone (S890).

When the user selects download of the original file in operation S891, the smartphone transmits a file download request File_Req including the token Tsa stored in the storage 751 to the low-speed storage server Sa of the cloud server (S892). When the file download request File_Req is received from the smartphone, the cloud server checks the token Tsa included in the file download request File_Req and then starts transmitting the original file (S893).

In the present embodiment, it is assumed that access to the high-speed storage server Sf and the low-speed storage server Sa is allowed through one credential check, but access to the high-speed storage server Sf and access to the low-speed storage server Sa may be separately performed as necessary.

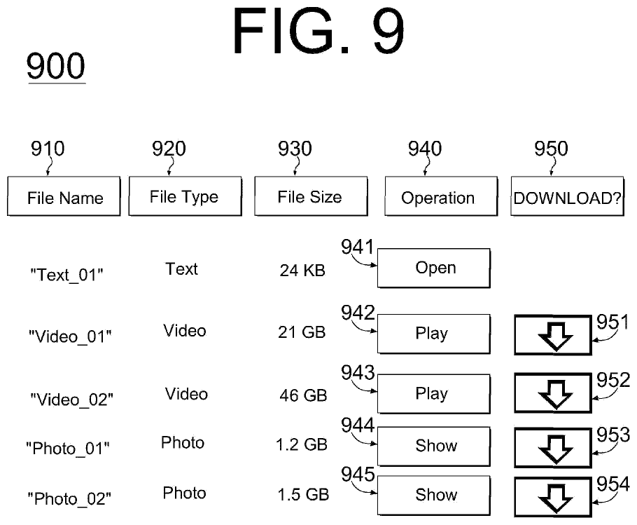

FIG. 9 is a screen of the smartphone on which a list 900 of files which are stored in the high-speed storage server Sf and received from the cloud server is displayed.

As shown in FIG. 9, the list of files may show attributes including a plurality of filenames 910 “Text_01,” “Video_01,” “Video_02,” “Photo_01,” and “Photo_02” stored in the high-speed storage server Sf, file types 920 of files, file sizes 930, operations 940 that the user may order for the files, download availability 950, etc. As file attributes, FIG. 9 shows attributes of original files (e.g., showing the sizes of original files instead of the sizes of reference files as the attribute of file size) because attributes of original files are more meaningful than attributes of reference files to the user. However, attributes of reference files may be displayed. Also, attributes of original files and reference files may be displayed together so that the user can better understand the attributes of the original files and the reference files.

The attribute of download availability 950 enables the user to download the original file of a corresponding file when the original file of the corresponding file is stored in the inexpensive low-speed storage server Sa. Specifically, “Text_01” is a text file and stored only in the expensive high-speed storage server Sf due to attributes thereof. Accordingly, the attribute of download availability 950 of “Text_01” does not show anything, representing that “Text_01” is not stored in the inexpensive low-speed storage server Sa. “Video_01” and “Video_02” are video files. Due to attributes of video files, proxy videos and original videos may be stored in the expensive high-speed storage server Sf and the inexpensive low-speed storage server Sa, respectively. When the user touches a play button 942 or 943, the smartphone may access the expensive high-speed storage server Sf through the Internet, download a proxy video file stored in the expensive high-speed storage server Sf, and display the downloaded proxy video to the user. When the user touches a download button 951 or 952, the smartphone may access the inexpensive low-speed storage server Sa through the Internet and download an original video file stored in the inexpensive low-speed storage server Sa.

“Photo_01” and “Photo_02” are photo files. Due to attributes of photo files, thumbnail image files and original image files may be stored in the expensive high-speed storage server Sf and the inexpensive low-speed storage server Sa, respectively. When the user touches a show button 944 or 945, the smartphone may access the expensive high-speed storage server Sf through the Internet, download a thumbnail image file stored in the expensive high-speed storage server Sf, and display the downloaded thumbnail image to the user. When the user touches a download button 953 or 954, the smartphone may access the inexpensive low-speed storage server Sa through the Internet and download an original video file stored in the inexpensive low-speed storage server Sa.

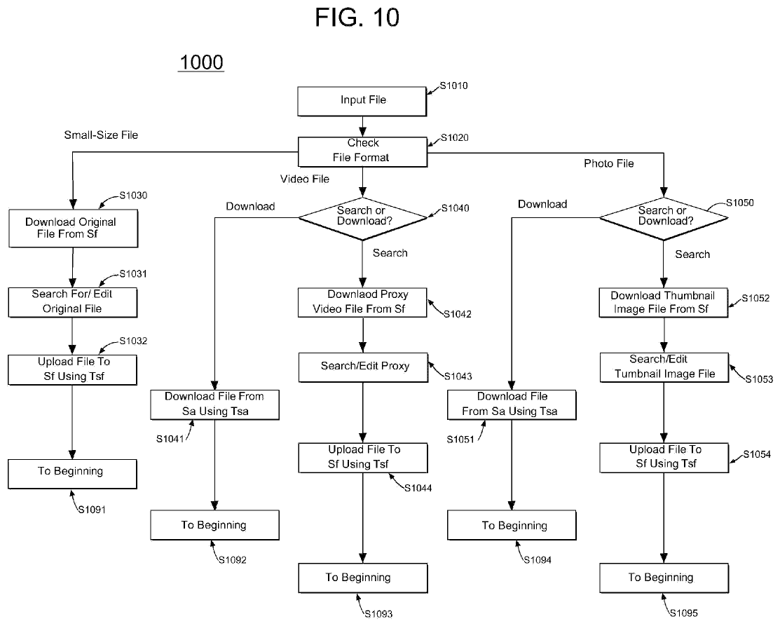

FIG. 10 is a diagram showing a process after a smartphone receives a list of files stored in the high-speed storage server Sf from the cloud server and displays the list 900 of files on the screen of the smartphone.

The user selects a file that he or she wants to search for or download by touching any one of execution icons shown in FIG. 9, for example, “Open” 941, “Play” 942 and 943, “Show” 944 and 945, and “Download” 951, 952, 953, and 954 (S1010).

Subsequently, the processor checks a format of a file corresponding to the touched execution icon (S1020). When the format of the file is a small-size file, such as a text file, the processor downloads the original small-size file from the high-speed storage server Sf using a token Tsf for the high-speed storage server Sf (S1030) and allows review and editing of the original small-size file on the screen of the smartphone (S1031). Subsequently, when the original small-size file is modified, the processor uploads the modified small-size file to the high-speed storage server Sf using the token Tsf for the high-speed storage server Sf (S1032). After that, the process returns to the beginning (S1091) so that the screen shown in FIG. 9 is displayed to the user.

When the selected file is found to be a video file (e.g., when the “Play” icon 942 or the “Download” icon 951 corresponding to “Video_01” is touched) as a result of checking the format of the file corresponding to the touched execution icon (S1020), the processor determines whether an operation for the file is a search or download (S1040). When a search operation is selected by the user, that is, when the user selects the “Play” icon 942 in the list 900 displayed to the user, the processor downloads a proxy video file from the high-speed storage server Sf (S1042) and displays the proxy video file to the user according to a general method well known in the technical field for the user to search for and/or edit the proxy video file (S1043). When the proxy video file is modified as a result of editing by the user, the processor uploads the modified proxy video file for the original file to the high-speed storage server Sf using the token Tsf for the high-speed storage server Sf (S1044) to update the proxy video file in the high-speed storage server Sf. After that, the process returns to the beginning (S1093) so that the screen shown in FIG. 9 is displayed to the user.

In one embodiment, cloud server S may be configured to detect whether the content of the proxy file uploaded at step S1044 has been modified by the user and, if the proxy file uploaded by the user has been modified by the user's editing, to detect the set of instructions used to edit the proxy file and apply the set of instructions to the original video file. For example, if it is determined that the user has performed editing such as cutting a specific scene or adjusting the color of a proxy file, i.e., rendering, cloud server S can detect the set of instructions used to edit the specific scene of the proxy file and perform editing such as cutting or adjusting the color of a specific scene of the corresponding original file in the same manner as the set of instructions used to edit the proxy file. This allows edition of the original file without degrading the power of the user's computer, and, at the same time, prompt reflection of changes applied to the proxy file in the original file.

When a download operation is selected by the user, that is, when the user selects the “Download” icon 951 in the list 900 displayed to the user, the processor starts downloading the original video file from the low-speed storage server Sa using a token Tsa for the low-speed storage server Sa (S1041). When the download of the original video file from the low-speed storage server Sa is completed, the process returns to the beginning (S1092) so that the screen shown in FIG. 9 is displayed to the user.

When the selected file is found to be a photo file (e.g., when the “Show” icon 944 or the “Download” icon 953 corresponding to “Photo_01” is touched) as a result of checking the format of the file corresponding to the touched execution icon (S1020), the processor determines whether an operation for the file is a search or download (S1050). When a search operation is selected by the user, that is, when the user selects the “Show” icon 944 in the list 900 displayed to the user, the processor downloads a thumbnail image file from the high-speed storage server Sf (S1052) and displays the thumbnail image file to the user according to a general method well known in the technical field for the user search for and/or edit the thumbnail image file (S1053). When the thumbnail image file is modified as a result of editing by the user, the processor uploads the modified thumbnail image file for the original file to the high-speed storage server Sf using the token Tsf for the high-speed storage server Sf (S1054) to update the thumbnail image file in the high-speed storage server Sf. After that, the process returns to the beginning (S1095) so that the screen shown in FIG. 9 is displayed to the user.

When a download operation is selected by the user, that is, when the user selects the “Download” icon 953 in the list 900 displayed to the user, the processor starts downloading the original photo file from the low-speed storage server Sa using the token Tsa for the low-speed storage server Sa (S1051). When the download of the original photo file from the low-speed storage server Sa is completed, the process returns to the beginning (S1094) so that the screen shown in FIG. 9 is displayed to the user.

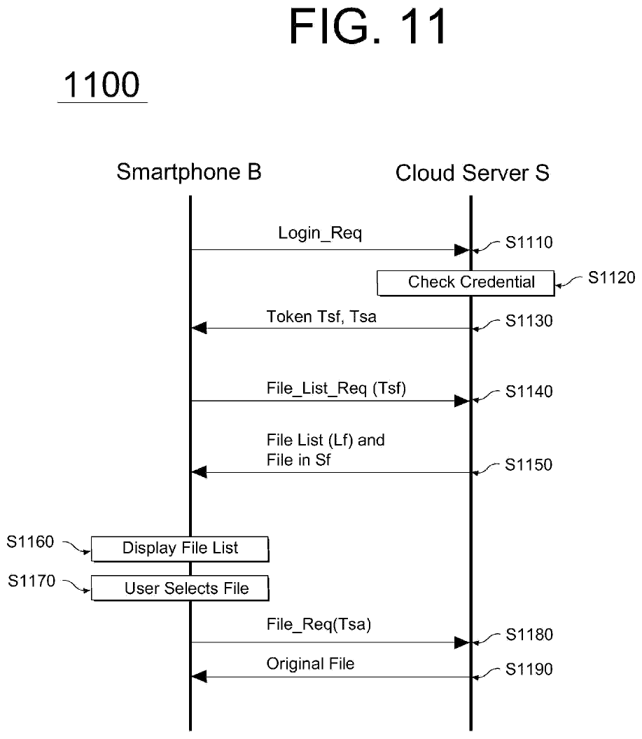

FIG. 11 is a sequence diagram illustrating a method of searching for a multimedia file stored in a cloud server through a smartphone or downloading the multimedia file to the smartphone according to another exemplary embodiment of the present disclosure.

When a user starts executing an access application Ba on the smartphone by clicking the icon of the application Ba, the smartphone transmits a login request Login_Req to the high-speed storage server Sf of the cloud server (S1110).

When the login request Login_Req is received from the smartphone, the cloud server checks the credential of the login request Login_Req (S1120). When it is determined that the login request Login_Req is valid as a result of checking the credential of the login request Login_Red, the cloud server issues tokens Tsf and Tsa respectively for access to the high-speed storage server Sf and the low-speed storage server Sa and transmits the tokens Tsf and Tsa to the smartphone (S1130). The mobile device 400, that is, the smartphone, receiving the tokens Tsf and Tsa from the cloud server stores the tokens Tsf and Tsa in the storage 751 thereof and requests transmission of a file list and files stored in the high-speed storage server Sf with the token Tsf (S1140). The cloud server checks the token Tsf included in the file list request and transmits a file list Lf and files stored in the high-speed storage server Sf to the smartphone (S1150).

The smartphone receives the file list Lf and files stored in the high-speed storage server Sf from the cloud server, stores the file list Lf and the files in the storage 751, and displays a list of files downloaded from the high-speed storage server Sf on the screen of the smartphone on the basis of the file list Lf (S1160).

The smartphone displays the file list including filenames of the files downloaded from the high-speed storage server Sf, the type of each file, file sizes, operations for the files, and download availability representing that the original file of a corresponding file is stored in the low-speed storage server Sa, to the user through the screen.

When the user selects download of an original file in operation S1170, the smartphone transmits a file download request File_Req including the token Tsa stored in the storage 751 to the low-speed storage server Sa of the cloud server (S1180). When the file download request File_Req is received from the smartphone, the cloud server checks the token Tsa included in the file download request File_Req and then starts transmitting the original file (S1190).

In the present embodiment, it is assumed that access to the high-speed storage server Sf and the low-speed storage server Sa is allowed through one credential check, but access to the high-speed storage server Sf and access to the low-speed storage server Sa may be separately performed as necessary.

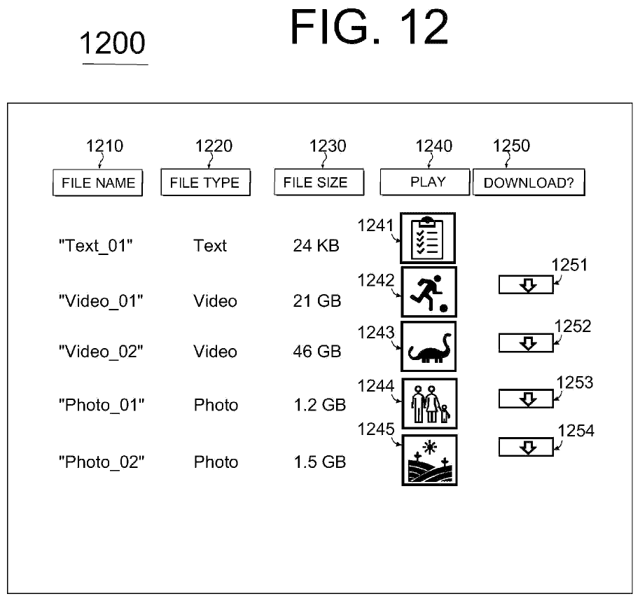

FIG. 12 is a screen of the smartphone on which a list 1200 of files which is downloaded from the high-speed storage server Sf is displayed. The screen shown in FIG. 12 is similar to that shown in FIG. 9. However, in the present embodiment, reference files (i.e., proxy video files and thumbnail image files) are stored in the storage 751 of the smartphone from the high-speed storage server Sf, and thus corresponding reference files 1242, 1243, 1244, and 1245 may be displayed on the screen instead of icons.

When the user touches an execution icon 1241 corresponding to the small-size file “Text_01” on the smartphone screen, the processor takes out the original text file “Text_01” stored in the storage 751 (S1330) and allows review and editing of the original small-size file on the screen of the smartphone (S1031). Subsequently, when the original small-size file is modified, the processor uploads the modified small-size file to the high-speed storage server Sf using the token Tsf for the high-speed storage server Sf (S1032). After that, the process returns to the beginning (S1091) so that the screen shown in FIG. 9 is displayed to the user.

When the user touches an execution icon 1242 corresponding to video file “Video_01” or an execution icon 1244 corresponding to the photo file “Photo_01” on the smartphone screen, the processor takes out the previously stored reference file “Proxy_Video_01” or “Thumb_Photo_01” from the storage 751 of the smartphone (S1342 or S1352) according to the present embodiment unlike in the embodiment shown in FIGS. 9 and 10 and displays the reference file to the user for the user to search for and/or edit the proxy video file (S1043). Since other operations are the same as illustrated in FIG. 9, detailed description thereof will be omitted.

According to another embodiment, after transmission to the cloud server is performed, transmission may be performed between the high-speed cloud server Sf and the low-speed cloud server Sa through the user's manipulation on the mobile device such as the smartphone.

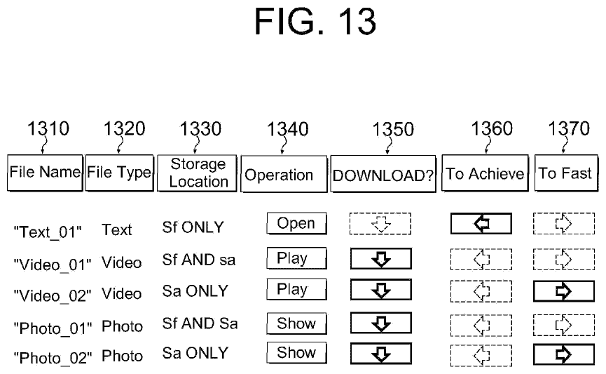

FIG. 13 is a screen illustrating a method of searching for a multimedia file stored in a cloud server through a smartphone or downloading the multimedia file to the smartphone according to another exemplary embodiment of the present disclosure.

Reference numerals 1310 and 1320 represent filenames and file attributes stored in the cloud server, respectively. A reference numeral 1330 represents where a reference file and an original file of a corresponding file are stored. For example, the file location “Sf ONLY” of the text file “Text_01” represents that the text file “Text_01” is stored only in the high-speed cloud server Sf. Also, the file location “Sf AND Sa” of the video file “Video_01” represents that the video file “Video_01” is stored in both the high-speed cloud server Sf and the low-speed cloud server Sa. The file location “Sa ONLY” of the video file “Video_02” represents that the video file “Video_02” is stored only in the low-speed cloud server Sa. In this case, the user may not only download the corresponding file to the mobile device but also move the corresponding file between the high-speed cloud server Sf and the low-speed cloud server Sa by selecting a download button 1350, a “To Archive” button 1360, or a “To Fast” button 1370. For example, the user may move the video file “Video_02” stored only in the low-speed cloud server Sa to the high-speed cloud server Sf by touching the “To Fast” button 1370 of the video file “Video_02” stored only in the low-speed cloud server Sa. In this way, a certain time after a file stored in the low-speed cloud server Sa is moved to the high-speed cloud server Sf, it is possible to download the video file “Video_02” from the high-speed cloud server Sf without a response delay.

According to the proposed invention, it is possible to reduce the cost of using a cloud storage device and increase the efficiency of network use by generating, in the case of storing video or photo files in the cloud storage device, summary files of the video or photo files as reference files, storing the reference files in a storage medium which takes a shorter time to respond to an access request but is expensive to use, and storing the original files having large sizes in a storage medium for keeping which takes a longer time to respond to an access request but is inexpensive to use.

Also, it is possible to reduce the number of unnecessary downloads of original files and minimize network usage by displaying reference files instead of original files for the purpose of a rapid search in the case of searching for photo or video files and allowing downloading of an original file only when it is necessary to download the corresponding photo or video file.

While the present disclosure has been described with reference to embodiments and the accompanying drawings, the present disclosure is not limited thereto. The present disclosure should be construed as encompassing various modifications that may be derived from the embodiments by those of ordinary skill in the art. The claims are intended to include such modifications.

1. A method of uploading a file to a remote server, the method comprising:
determining a format of an original file to be uploaded;
when the original file is determined to be a large-size file, generating a reference file having a smaller size than the original file;
transmitting the reference file to a first server using a first token;
transmitting the original file to a second server using a second token;
receiving the reference file from the first server;
editing the reference file based on instructions from a user; and
transmitting the edited reference file to the first server,
wherein the second server takes a longer time than the first server to respond to an access request.

2. The method of claim 1, wherein the original file is a video file, and
the reference file is a proxy video file.

3. The method of claim 1, wherein the original file is a photo file, and
the reference file is a thumbnail image file.

4. A method of downloading a file, the method comprising:
displaying a list of reference files on a screen;
selecting a first reference file from among the reference files according to an input of a user;
downloading the first reference file from a first server using a first token;
downloading an original file corresponding to the first reference file from a second server using a second token;
editing the first reference file based on instructions from a user;
transmitting the edited reference file to the first server;
applying the instructions from the user to the original file; and
transmitting the original file to the second server,
wherein the second server takes a longer time than the first server to respond to an access request.

5. The method of claim 4, wherein the list of reference files includes location information of the original file.

6. The method of claim 4, wherein the first reference file is generated from the original file.

7. A device for uploading a file, the device comprising:
a memory configured to store program instructions; and
a processor connected to the memory and configured to operate according to the program instructions,
wherein the program instructions cause the processor to perform operations of:
determining a format of an original file to be uploaded;
when the original file is determined to be a large-size file, generating a reference file having a smaller size than the original file;
transmitting the reference file to a first server using a first token;
transmitting the original file to a second server using a second token;
receiving the reference file from the first server:
editing the reference file based on instructions from a user; and
transmitting the edited reference file to the first server,
wherein the second server takes a longer time than the first server to respond to an access request.

8. The device of claim 7, wherein the original file is a video file, and
the reference file is a proxy video file.

9. The device of claim 7, wherein the original file is a photo file, and
the reference file is a thumbnail image file.

10. A terminal comprising:
a memory configured to store program instructions; and
a processor connected to the memory and configured to operate according to the program instructions,
wherein the program instructions cause the processor to perform operations of:
displaying a list of reference files on a screen;
selecting a first reference file from among the reference files according to an input of a user;
downloading the first reference file from a first server using a first token;
downloading an original file corresponding to the first reference file from a second server using a second token;
editing the first reference file based on instructions from a user;
transmitting the edited reference file to the first server;
applying the instructions from the user to the original file; and
transmitting the original file to the second server,
wherein the second server takes a longer time than the first server to respond to an access request.

11. The terminal of claim 10, wherein the original file is a video file, and
the reference file is a proxy video file.

12. The terminal of claim 10, wherein the original file is a photo file, and
the reference file is a thumbnail image file.

13. The method of claim 1, wherein the editing the reference file comprises cutting a portion of the reference file.

14. The method of claim 1, further comprising:
subsequent to receiving the reference from the first server, receiving the original file from the second server;
generating editing instructions based on the instructions from the user;
applying the editing instructions to the original file; and
subsequent to applying the editing instructions, transmitting the original file to the second server.

15. The method of claim 1, further comprising:
subsequent to editing reference file, generating editing instructions based on the instructions from the user;
transmitting the editing instructions to the second server.

16. The method of claim 1, wherein the editing the reference file comprises applying an effect to a portion of the reference file.

17. The method of claim 1, further comprising:
detecting whether content of the edited reference file has been modified; and
if the content has been modified, generating a set of editing instructions based on the modifications.

18. The method of claim 17, further comprising:
applying the set of editing instructions to the original file stored in the second server.

19. The method of claim 1, further comprising:
storing metadata associated with the reference file, the metadata including link information to the original file stored in the second server.
